(19) United States
(12) Patent Application Publication
(10) Pub. No.: US 2019/0165411 A1
(43) Pub. Date: May 30, 2019

(54) Porous-electrode Lithium-ion Battery

(71) Applicants: Huan Tu, Shenzhen (CN); Chang-Yong Yang, Shenzhen (CN)

(72) Inventors: Huan Tu, Shenzhen (CN); Chang-Yong Yang, Shenzhen (CN)

(21) Appl. No.: 15/825,124

(22) Filed: Nov. 29, 2017

(51) Int. Cl. H01M 10/0525; H01M 2/02

(52) U.S. Cl. CPC H01M 10/0525; H01M 2/0292; H01M 2/022

(57) ABSTRACT

This invention revolves around a new porous-electrode lithium-ion battery, including a cap, an anode tab, a winder, a cathode tab, and a battery core shell. The anode and cathode tabs are located at the upper and lower parts of the winder, respectively, and the battery core shell at the outermost part of the battery. A cap is designed at the top of the winder equipped with anode and cathode, between which there is separation paper. The anode has a front coating as well as a back coating. This invention punches numerous pores in the anode or cathode and then fills the pores with anode or cathode materials. From the perspective of physics, this can increase the volume of anode or cathode materials to maximize the room for electrons and then improve battery capacity. The invention which can heighten battery capacity in unit volume raises the range of the energy vehicles by 25% or reduces the weight of vehicle body.

### BACKGROUND OF THE INVENTION

### Field of the Invention

This invention revolves around a new porous-electrode lithium-ion battery, which falls within the technical scope of lithium-ion battery.

### Description of the Related Art

Along with the popularity and wide use of new energy vehicles (all-electric rechargeable vehicles) as well as the intelligent and convenient application of handheld devices in people's life and work, people make a higher demand on the battery packs in vehicles or the battery capacity of the handheld devices like mobile phones and laptops. Existing lithium-ion battery material systems are made up of carbon cathode, lithium cobalt oxide and organic electrolyte. However, existing lithium-ion battery material systems are incapable of raising battery capacity in unit volume. For this reason, there is a need to change internal structures and the admission space of ions for the sake of higher battery capacity in unit volume without altering material systems. As for users, automobiles exploiting the batteries produced by such structural technology can increase their range by 25%, and the handheld devices adopting such batteries can also raise their endurance by 25%.

No matter what kind of materials is used to produce anode or cathode of battery, it is required to be evenly plastered on conductive carriers, i.e., electrodes. In this way, the ions within such material can transfer electrons in forward or reverse directions. Traditional technique tends to plaster the cathode materials evenly on the front and back sides of the smooth copper foil, and the anode materials on the front and back sides of the smooth aluminum foil, with the plastering area equal to battery capacity.

### BRIEF SUMMARY OF THE INVENTION

The aim of this invention is to provide a new porous-electrode lithium-ion battery for the purpose of improving the endurance of the lithium-ion battery.

To attain the goal above, this invention comes up with the technical scheme below.

The new porous-electrode lithium-ion battery includes a cap, an anode tab, a winder, a cathode tab, and a battery core shell. The anode and cathode tabs are located at the upper and lower parts of the winder, respectively, and the battery core shell at the outermost part of the battery. A cap is designed at the top of the winder. The winder is equipped with anode and cathode, between which there is separation paper. The anode has a front coating as well as a back coating, and so does the cathode. The outer sides of the anode and cathode are connected with the anode and cathode tabs that link up with the external charging and discharging ports, respectively. The coatings on the anode or cathode are electron and ion storage carriers.

Furthermore, the anode and cathode that are filled with the pores like hollow cylinders or honeycombs. The coatings on the electrodes are put into the hollow pores. The filling materials linked to the front and back coatings constitute a whole with the coatings on the front and back sides of the electrodes. Every coating is equipped with electrons as well as ions that can attain the goal of electron conduction through pore walls. The materials added to the pores are the expanded volume, its sizes depending on the pore size and the thickness of tab. The ions are released or embedded through the front or back coatings, and the electrons are conducted to the tabs through pore walls, i.e., electrode materials.

Below are the benefits of this invention: this invention punches numerous pores in the anode or cathode and then fills the pores with anode or cathode materials. From the perspective of physics, this can increase the volume of anode or cathode materials to maximize the room for electrons and then improve battery capacity. The invention which can heighten battery capacity in unit volume raises the range of the energy vehicles by 25% or reduces the weight of vehicle body. As for handheld devices, this invention can prolong their endurance as well as reduce their charging frequency and product size.

### BRIEF DESCRIPTION OF THE SEVERAL VIEWS OF THE DRAWING(S)

FIG. 1: Schematic Diagram of the Invention's Structure

FIG. 2: Internal Structural Diagram of the Specific Implementation Case of This Invention

FIG. 3: Detailed Structural Diagram of the Specific Implementation Case of This Invention

FIG. 4: The Structural Diagram of the Invention's Coating

Explanations on the marks of the Figures: 1. Cap; 2. Anode tab; 3. Winder; 4. Cathode tab; 5. Battery core shell; 6. Front coating of anode; 7. Anode; 8. Back coating of anode; 9. Separation paper; 10. Front coating of anode; 11. Cathode; 12. Back coating of cathode.

### DETAILED DESCRIPTION OF THE INVENTION

A description is made on the specific implementation mode of this invention in combination with the figures for the purpose of understanding this invention better.

Cases

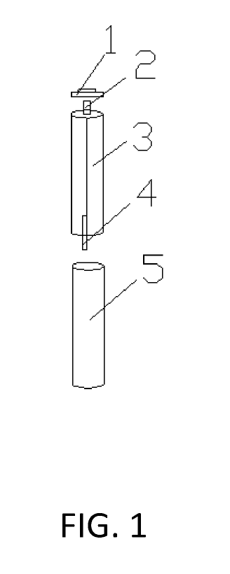

As shown by FIG. 1, the lithium-ion battery is equipped with a cap 1, an anode tab 2, a winder 3, a cathode tab 4, and a battery core shell 5. The anode tab 2 or cathode tab 4 are located at the upper and lower parts of the winder 3, respectively, and the battery core shell 5 at the outermost part of the battery. A cap 1 is designed at the top of the winder 3.

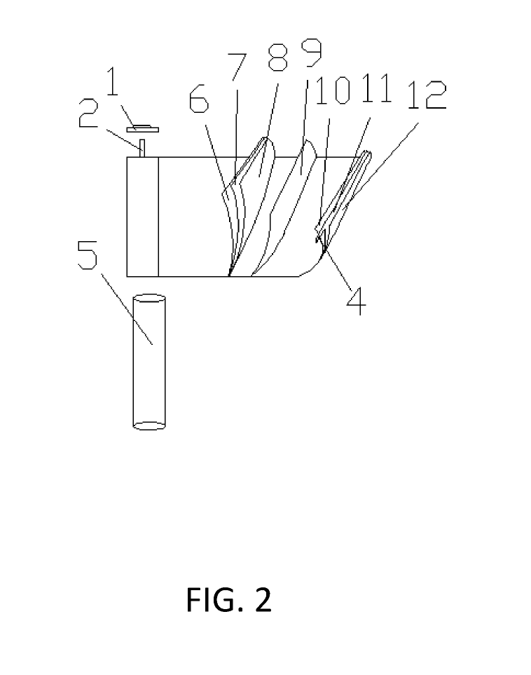

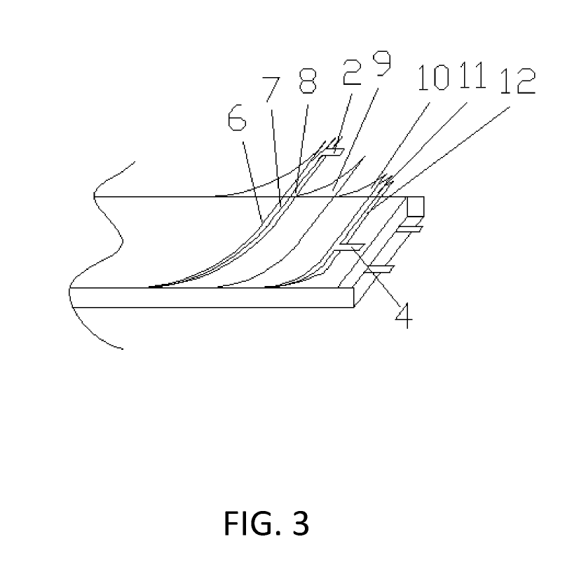

FIGS. 2 and 3 demonstrate the internal structure of the lithium-ion battery. The winder 3 is equipped with anode 7 or cathode 11, between which there is separation paper 9. The anode 7 has a front coating 6 as well as a back coating 11, and the cathode consists of a front coating 10 and a back coating 12 as well. The outer sides of the anode 7 or cathode 11 are connected with the anode tab 2 or cathode tab 4 that link up with the external charging and discharging ports, respectively. The coatings on the anode or cathode are electron and ion storage carriers.

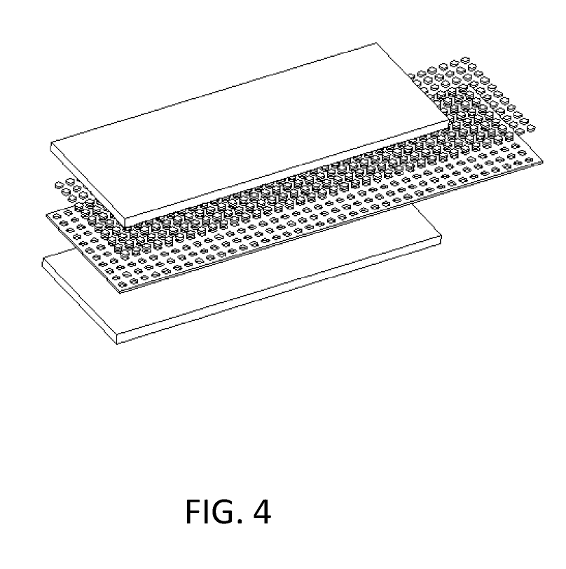

As revealed by FIG. 4, the anode and cathode that are filled with the pores like hollow cylinders or honeycombs. The coatings on the electrodes are put into the hollow pores. The filling materials linked to the front and back coatings constitute a whole with the coatings on the front and back sides of the electrodes. Every coating is equipped with electrons as well as ions that can attain the goal of electron conduction through pore walls. The materials added to the pores are the expanded volume, its sizes depending on pore size and the thickness of tab. The ions are released or embedded through front or back coatings, and the electrons are conducted to the tabs through pore walls, i.e., electrode materials.

All the above are the preferred implementation modes of this invention. It is worth noticing that the improvements and modifications made by ordinary technicians in this field on the premise of following the principle of this invention should be considered within the protective scope of this invention.

1. The new porous-electrode lithium-ion battery includes a cap, an anode tab, a winder, a cathode tab, and a battery core shell. The anode and cathode tabs are located at the upper and lower parts of the winder, respectively, and the battery core shell at the outermost part of the battery. A cap is designed at the top of the winder. The winder is equipped with anode and cathode, between which there is separation paper. The anode has a front coating as well as a back coating, and so does the cathode. The outer sides of the anode and cathode are connected with the anode and cathode tabs that link up with the external charging and discharging ports, respectively. The coatings on the anode or cathode are electron and ion storage carriers.

2. As described by claim 1, the new porous-electrode lithium-ion battery is characterized by the anode and cathode that are filled with the pores like hollow cylinders or honeycombs. The coatings on the electrodes are put into the hollow pores. The filling materials linked to the front and back coatings constitute a whole with the coatings on the front and back sides of the electrodes. Every coating is equipped with electrons as well as ions that can attain the goal of electron conduction through pore walls.
